(19) United States
(12) Patent Application Publication
(10) Pub. No.: US 2016/0128164 A1
(43) Pub. Date: May 5, 2016

(54) LIGHTING MEANS HAVING A PRESENCE SENSOR AND A COMMUNICATION MEANS

(71) Applicant: COMFYLIGHT AG, Zurich (CH)

(72) Inventor: Marcus KOEHLER, Stauchitz OT Ragewitz (DE)

(73) Assignee: COMFYLIGHT AG, Zürich (CH)

(21) Appl. No.: 14/892,608

(22) PCT Filed: May 13, 2014
(86) PCT No.: PCT/EP2014/059764

§ 371 Date: Nov. 20, 2015

(30) Foreign Application Priority Data
May 21, 2013 (DE) 10 2013 209 317.9

(51) Int. Cl. H05B 37/02; H05B 33/08

(52) U.S. Cl. CPC H05B 37/0227; H05B 33/0854; H05B 37/0272; H05B 37/0263

(57) ABSTRACT

The invention proposes a lighting means (1) comprising a light generator (2) and a socket (3) for electrically connecting to a standardised lamp socket, a presence sensor (4) and a communication module (5) also being provided in said lighting means. Data collected by the presence sensor (4) are forwarded via radio or power-line signals by means of the communication module (5).

### PRIOR ART

The invention is based on a lighting means of the generic type in the independent claim. Lamps in which a presence sensor is connected to a light generator are already known. If a person is detected by the presence sensor, the light generator is actuated, and so light is provided to the person detected in this way. In this manner, lighting can be generated as needed. In addition to conventional light bulbs, LED bulbs are commonly used as light generators.

### DISCLOSURE OF THE INVENTION

### Advantages of the Invention

The lighting means according to the invention makes it possible for the data from the presence sensor to be provided to other units where is can be used for other control tasks. In addition to actuating the light generator, further functions relating to the presence of a person can thus also be controlled.

Further advantages and improvements are produced by to the features in the dependent claims. The lighting means can also receive relevant data from further presence sensors and use said data for controlling the light generator. For example, the actuation of the light generator can depend not only on the data from the presence sensor thereof, but also on the data from the further presence sensors. Use can be made of this in a particularly simple manner if the control of the light generator, for example the switching on or off of the light generator, depends not only on the data from the presence sensor thereof, but also on the data from a further presence sensor. In this case, the control of the light generator can depend on the probability of the presence of a person being compared with a threshold value. Depending on the data from further presence sensors, the threshold value can be increased or decreased. The presence sensor is formed in a particularly simple manner as an ultrasonic, radar or infrared sensor, or a combination of said sensors. The communication module is formed in a particularly simple manner as a WLAN or ZigBee module. The light generator can, for example, be an LED because in this way high luminous efficacy and only a small amount of waste heat, which could damage the other electronic units of the lighting means, is kept low while a small amount of power is consumed . . . .

Embodiments of the invention are shown in the drawings and described in more detail in the following description. In the drawings:

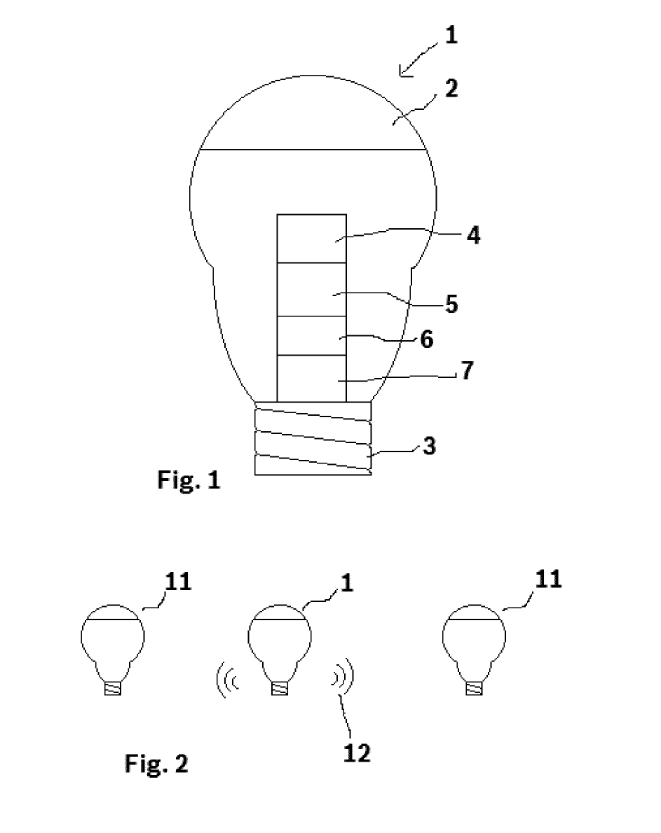

FIG. 1 shows a lighting means according to the invention, and

FIG. 2 shows a plurality of lighting means according to the invention.

### DESCRIPTION

FIG. 1 shows a lighting means 1 according to the invention, which, in terms of its outer shape, is formed like a conventional light bulb. The lighting means 1 according to the invention comprises a light generator 2, which is arranged in this case, for example, in the upper region of the light bulb-like body of the lighting means 1. At the lower end, the light bulb-like body of the lighting means 1 has a socket 3, which is a standard socket for screwing into a suitable lamp socket. Typically, said socket 3 can be an E27 or E14 threaded socket, as is common for conventional light bulbs. Other electric connection systems or sockets, such as plug-in sockets, bayonet sockets or the like, are however also known.

In addition to the light generator 2, a presence sensor 4, a communication module 5 and a controller 6 are arranged inside the lighting means 1. A further sensor 7 may also optionally be provided.

The light generator 2 is preferably an LED (light emitting diode). LEDs of this type are advantageous in that high luminous efficacy is achieved while a low amount of power is consumed. As a result of this high luminous efficacy, the losses produced by the LED and thus the amount of heat generated by the LED are also low. In the drawing in FIG. 1, the light generator 2 is arranged in a region remote from the socket 3. Other arrangements to the right and to the left, or entirely in an annular structure around the lighting means 1 are also conceivable, depending on the desired radiation pattern of the light generator 2.

Owing to the socket 3 and the light generator 2, the lighting means according to the invention can be used in the same way as a conventional light bulb. Therefore, a lighting means is provided, for example, at a central point in the middle of a room, which lighting means can be integrated in the installation that is currently the standard in housing and offices. In addition to this simple function as a conventional lighting means, the lighting means according to the invention can also perform a plurality of other functions.

By means of the presence sensor 4, the presence of people or vehicles can be detected in a detection region of the lighting means 1 or the presence sensor 4. Typically, a presence sensor 4 of this type is an infrared, radar or ultrasonic sensor. The use of radar is advantageous in that the presence of people, vehicles or the like can be detected by means of possible lamp components surrounding the lighting means 1. Alternatively, this can also be achieved by an appropriately designed lighting means 1 being used directly, without a surrounding enclosure. Furthermore, a direction of movement can also be detected by means of radar. Additionally, different sensors can also be combined with one another; for example, an infrared sensor and a radar sensor can both be provided, the data from which are used together in order to detect the presence of people or vehicles or other objects, animals or the like which require lighting.

A communication module 5 is also arranged in the lighting means 1 according to the invention and is designed to send out data from the presence sensor 4 via corresponding communication signals. Data from the presence sensor 4 is to be understood here not only as direct raw data from the presence sensor 4, but also as data which are derived therefrom, i.e. post-processed data. The communication module 5 is also designed to receive external signals, for example from other presence sensors or control signals. The communication module 5 is typically connected to a controller 6 which obtains the signals from the communication module 5 or receives data from the presence signal 4 and converts said data into corresponding signals for the communication module 5. The controller 6 is thus designed not only to obtain data from the communication module 5 or to generate data for the communication module 5, but also to control the light generator 2. Additionally, further sensors 7 can also be provided in the lighting means 1. A typical example of such a sensor would be a smoke detector or a flame detector, which can detect if a fire breaks out, and these data are relayed accordingly by means of the communication module 5.

The communication module 5 is typically designed for communicating via an electrical line or by radio. In the case of communication via an electrical line, for example all processes which transmit the communication signals via a power supply line are useful. Such processes are usually referred to as power-line communication. The communication signals are then fed into the power supply network or received from said network via the socket. In the case of communication via radio, all wireless processes are suitable, for example WLAN, ZigBee, Bluetooth, DECT, GSM, UMTS and all other wireless interfaces used in particular in standardised radio interfaces.

The lighting means according to the invention can, for example, be controlled by means of the communication module 5 and the controller 6. For example, the communication module can receive a command by means of which the controller switches the light generator 1 on or off. Commands can also be provided by means of which the light produced by the light generator 2 is modified. For example, the light generator 2 can be influenced in terms of the generated light intensity or light colour. The communication module 5 and the controller 6 connected thereto which actuates the light generator 2 can thus be used to control the lighting means 1 remotely; for example, the lighting means 1 can be controlled by means of a mobile telephone having a WLAN connection.

The lighting means 1 can be used with other similar lighting means, improved actuation of the individual lighting means being achieved as a result. This is for example shown in FIG. 2, in which a first lighting means 1 and, by way of example, two further lighting means 11 are shown. It would however also be reasonable to have larger groups of lighting means. Radio waves 12 are also schematically shown, by means of which the lighting means 1 sends signals, in particular data from the presence sensor 4 of the lighting means 1, to the further lighting means 11. Accordingly, the further lighting means 11 can also send data from the presence sensors 4 thereof to the first lighting means 1. Likewise, presence sensors 4 without lighting means can be provided. Owing to this data exchange between the different lighting means according to the invention, the quality of the actuation of the light generators 2 in the lighting means 1, 11 can be improved.

The various presence sensors each send a measuring signal which can draw a conclusion on the presence of people, vehicles or the like. In the process, there is some uncertainty, for example when a person approaches the detection region of a presence sensor 4, and therefore, in an external region, the approaching person initially only produces a very weak signal. The closer the person gets to the presence sensor 4, the stronger and clearer the detection of the person by the presence sensor 4. The signal from the presence sensors 4 is thus weighted with a probability of detecting a person, i.e. when the signal from the presence sensors is immediately analysed, there is an uncertainty range in which it is unclear whether a person is present or not. This uncertainty range, in which it is not entirely clear on the basis of the probability of detecting a person whether a person is approaching the lighting means 1 or whether a person has stopped within the region of the lighting means 1, can be improved by the communication between different lighting means. If, for example, in FIG. 2, the middle lighting means 1 clearly detects that a person is present, this definite detection of a person is communicated to the further lighting means 11 by means of the radio waves 12 shown schematically in FIG. 2. These lighting means can then weight a signal from the presence sensors differently in such a way that, if the central lighting means 1 has detected a person when the threshold of the presence sensors is very low, it can be assumed that the person has moved from the central lighting means 1 to one of the further lighting means 11. This means that each lighting means not only consults the data from the presence sensor 4 thereof, but also the data from further presence sensors 4 of neighbouring lighting means, in order to decide whether a person is in the lighting region of the lighting means 1. This can take place particularly simply by a threshold value for the signals from the presence sensors being provided once the presence of a person has been detected. If radio signals have been received from further presence sensors which indicate that people are present, this threshold value is reduced, and therefore the sensitivity to detecting people is lowered. The detection of people can thus be improved by a plurality of lighting means communicating with one other.

If at least one of the presence sensors 4 can also detect a direction of movement (for example a radar sensor), this information can be used to improve the presence detection of the other presence sensors 4. The sensor that also detects the direction of movement sends information concerning the direction of movement to the other presence sensors 4 which use this information to improve their own presence detection.

The signals from the presence sensors can also be used to decide that no person is left in the region of a particular lighting means. For example, in a long corridor which is equipped with a plurality of lighting means, in the case of a movement pattern in which lighting means arranged next to one another in succession detect a person and a direction of movement of this person, the lighting means behind the moving person in each case can be switched off more quickly. This is particularly advantageous when the lighting means are usually only switched on for a certain minimum period on the basis of the presence sensor thereof. If a clear movement of the person is detected on the basis of a plurality of lighting means, which are, for example, arranged in a long corridor, the lighting means arranged in a region in which no person is left can be switched off more quickly. Since the reliability of the presence information is improved by the plurality of movement sensors in the lighting means, can accordingly also be switched off more quickly.

Alternatively, it is also possible to associate brightness control with the probability of a person being present. For example, if neighbouring lighting means detect that a person is present, even when the probability that the person is heading towards a particular lighting means is low, the lighting means is first actuated with a low intensity, which is increased as the degree of probability that a person is coming into the lighting region of the lighting means increases. A person in the region of this lighting means would thus always be surrounded by a lit-up region, the light intensity of which decreases at the edge regions.

Furthermore, the communication module 5, the controller 6 and the presence sensor 4 can also be used for other control tasks. For example, if a person is detected in a room, the heating, air-conditioning or the like is controlled accordingly. Furthermore, the communication module 5 can be used to introduce further data into the lighting means 1. For example, if the building comprises an external light sensor, it can be determined, on the basis of the external lighting intensity, whether lighting is required in a room when a person is therein. In the process, this can be adapted to each lighting means individually; for example, the specific threshold for a particular lighting means can be different in a room with a very high number of windows by comparison with a room that only has very few window areas or no windows at all.

Furthermore, the communication module 5 can also be used to forward data from further sensors 7, for example from smoke detectors, flame detectors or brightness sensors. In addition to functioning as a lighting means, the lighting means 1 can thus also perform further functions, in particular of further sensors 7 which can be arranged in the lighting means 1. These data can then be transmitted not only from lighting means to lighting means, but also in particular to a central unit for receiving radio signals from the communication modules 5. An installation of this type is particularly useful in fire alarm systems. Furthermore, the individual lighting means can also be centrally actuated by means of a central station of this type. For example, a resident of the house can switch lighting therein on and off using a remote controller. For this purpose, the central station should in particular be connected via the Internet or a telephone line.

The information from brightness sensors can be used to actuate lights as needed. In the process, the brightness sensor can analyse a wave length which is not generated by the light generator 2 thereof or by the neighbouring light generators 2. In this manner, daylight or sunlight can be distinguished from artificial lighting, and the light generators 2 are actuated accordingly. In this respect, it can be useful to arrange brightness sensors only in close proximity to windows and to then also transmit information thus obtained to light generators at a greater distance from the window. In this manner, a twilight state can be distinguished by an arrangement further away from a window.

1.-9. (canceled)

10. A lighting means (1) comprising a light generator (2) and a socket (3) for electrically connecting to a standardised lamp socket, further comprising a presence sensor (4) and a communication module (5), the communication module (5) forwarding data via radio signals, which data are acquired by the presence sensor.

11. The lighting means of claim 10, wherein the communication module (5) receives data which are transmitted from at least one further presence sensor (4) by means of communication modules (5).

12. The lighting means of claim 10, wherein the data from the presence sensor (4) is assigned a probability of detecting a person in a detection region of the presence sensor (4), and a controller (6) actuates the light generator (2) on the basis of this probability.

13. The lighting means of claim 12, wherein the controller (6) for controlling the light generator (2) actuates the light generator (2) on the basis of data from the presence sensor (4) and from one further presence sensor (4), which data are obtained by means of the communication module (5).

14. The lighting means of claim 13, wherein the controller (6) for controlling the light generator (2) compares the probability with a threshold value, and the threshold value is modified by the data from the further presence sensors (4), which data are obtained by means of the communication module (5).

15. The lighting means of claim 10, wherein the presence sensor (4) detects the presence of a person or a vehicle in response to radar signals, ultrasonic signals or infrared signals.

16. The lighting means of claim 10, wherein the communication module (5) is a WLAN, ZigBee, Bluetooth, DECT, GSM, or UMTS communication module.

17. The lighting means of claim 10, wherein the communication module (5) is designed as a power-line communication module.

18. The lighting means of claim 10, wherein the light generator (2) is an LED.
